(19) United States
(12) Patent Application Publication
(10) Pub. No.: US 2022/0118752 A1
(43) Pub. Date: Apr. 21, 2022

(54) SYSTEM AND METHOD FOR MASS PRODUCING TEMPLATES FROM PLASTIC FILM

(71) Applicant: ESSENTIAL SAFETY PPE, LLC, Spring, TX (US)

(72) Inventors: Ilo Ray Floyd, JR., Houston, TX (US); Chad Alan Hawkins, Katy, TX (US); Robert Lee McPheron, IV, Tomball, TX (US)

(21) Appl. No.: 17/071,926

(22) Filed: Oct. 15, 2020

(51) Int. Cl. B32B 38/00; B32B 38/18; B32B 27/08

(52) U.S. Cl. CPC B32B 38/0004; B32B 27/08; B32B 38/1808

(57) ABSTRACT

An apparatus for unrolling film to a desired length and rapidly cutting multiple sheets of a desired size. The sheets can then be further processed and cut using templates. The system can have a polygonal wheel, an axle slot for receiving a roll of film, a first fastener for attaching the film to the polygonal wheel, a cutter for cutting the film into sheets and a second fastener for forming a stack of sheets of film. The stack of sheets can be further cut with a second cutter into a desired shape.

### FIELD

The present disclosure generally relates to a system and method for mass producing templates from plastic film.

### BACKGROUND

Many items are created from plastic sheets or plastic film. Often, the raw material comes in large rolls that must be unrolled and cut to specific lengths based upon the article being manufactured.

Rolls of plastic are often cumbersome to handle or unroll due to various factors, such as static attraction of the plastic to itself, uneven stretching of the plastic, damage or tearing of the material, and the like.

Often the process of cutting desired lengths of plastic, creating a template and manufacturing an article is a manual process which is costly, time consuming, and labor intensive.

The present disclosure provides an improved system and method of mass producing templates from rolls of plastic to manufacture items.

### BRIEF DESCRIPTION OF THE DRAWINGS

The detailed description will be better understood in conjunction with the accompanying drawings as follows:

FIG. 1 depicts a perspective view of an embodiment of the system for mass producing templates from plastic film.

FIG. 2 depicts a perspective view of an embodiment of the system for mass producing templates from plastic film with a roll of plastic film.

FIG. 3A depicts a perspective view of an embodiment of the system for mass producing templates from plastic film with the film being unrolled.

FIG. 3B depicts a perspective view of an embodiment of the system for mass producing templates from plastic film with the film being unrolled.

FIG. 4 depicts a perspective view of an embodiment of the system for mass producing templates from plastic film with the film have been unrolled.

FIG. 5 depicts a perspective view of an embodiment of the system for mass producing templates from plastic film.

FIG. 6 depicts a perspective view of an embodiment of a cutter for the system for mass producing templates from plastic film.

The embodiments of the present disclosure are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present embodiments.

Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a system and method for mass producing templates from plastic film.

The system makes use of a novel apparatus for unrolling plastic film to a desired length and rapidly cutting multiple plastic sheets of a desired size. The plastic sheets can then be further processed and cut using templates.

The system can have a polygonal wheel, an axle slot for receiving a roll of film, a first fastener for attaching the film to the polygonal wheel, a cutter for cutting the film into sheets and a second fastener for forming a stack of sheets of film.

The system can comprise an axle slot to receive an axle comprising a roll of film, wherein the axle allows the roll of film to rotate freely. The axle can be supplied as part of the system, or a structure upon which the plastic film is rolled can be used as the axle. The axle can be a dowel, a rod, a tubular, a cylinder, a hollow cylinder, and the like. The axle need not be cylindrical throughout, as long as the portions within the axle slot are substantially cylindrical and can rotate freely.

The system can comprise a polygonal wheel, wherein a width of the polygonal wheel is at least a width of the roll of film, and further wherein each side of the polygon is of a user defined length. The type of polygon can be determined by persons having ordinary skill in the art based upon the number of plastic sheets needed, space available, size(s) of plastic sheet needed, thickness of the plastic film, and the like.

The system can comprise a first fastener to removably attach film from the roll of film to the polygonal wheel. Any fastener known to persons having ordinary skill in the art can be used for attachment. Based upon the characteristics of the plastic film and the lengths of plastic sheet desired appropriate fasteners can be selected.

Upon attachment, rotation of the polygonal wheel can wrap the plastic film about the polygonal wheel. A motor can be provided to rotate the polygonal wheel.

The system can comprise a cutter for cutting the film from the roll of film into sheets of film of a user defined length. While typically it is simplest to cut at the vertices of the polygon across the width of the polygonal wheel, the cuts can be made in any manner desired by persons having ordinary skill in the art.

The system can comprise a second fastener for fastening the sheets of film to form a stack of sheets of film. Exemplary second fasteners include, but are not limited to: staples, clips, vice grips, glue, use of a heat gun to seal, and the like.

The system can comprise a second cutter for cutting templates in the stack of sheets. The stack of sheets can be simultaneously cut to a desired shape, thereby saving time and reducing costs of cutting the plastic sheets into a specific pattern.

In embodiments, the width of the polygonal wheel is adjustable. This can be accomplished by adding or removing pieces to the polygonal wheel, having a sliding or telescoping member defining the width, or other similar means as known to persons having ordinary skill in the art. In a similar manner the user defined length is adjustable by adjusting the length of the sides of the polygon comprising the polygonal wheel. The polygon can be manipulated or changed by adding or removing sides from the polygonal wheel.

In embodiments, the polygonal wheel in cross section can be a triangle, a quadrilateral, a pentagon, a hexagon, a heptagon, or an octagon. In embodiments, the polygonal wheel in cross section can be a regular polygon. In other embodiments, it can be an irregular polygon.

A method for mass producing templates from plastic film can include providing the system as described above, placing the roll of film on an axle within the axle slot, using the first fastener to connect the film from the roll of film to the polygonal wheel, rotating the polygonal wheel such that the film is wrapped about the polygonal wheel, cutting the film while attached to the polygonal wheel to form sheets of film, using the second fastener to fasten the sheets of film to form the stack of sheets of film, cutting a template into the stack of sheets of film, separating the stack of sheets of film into separate sheets cut into templates.

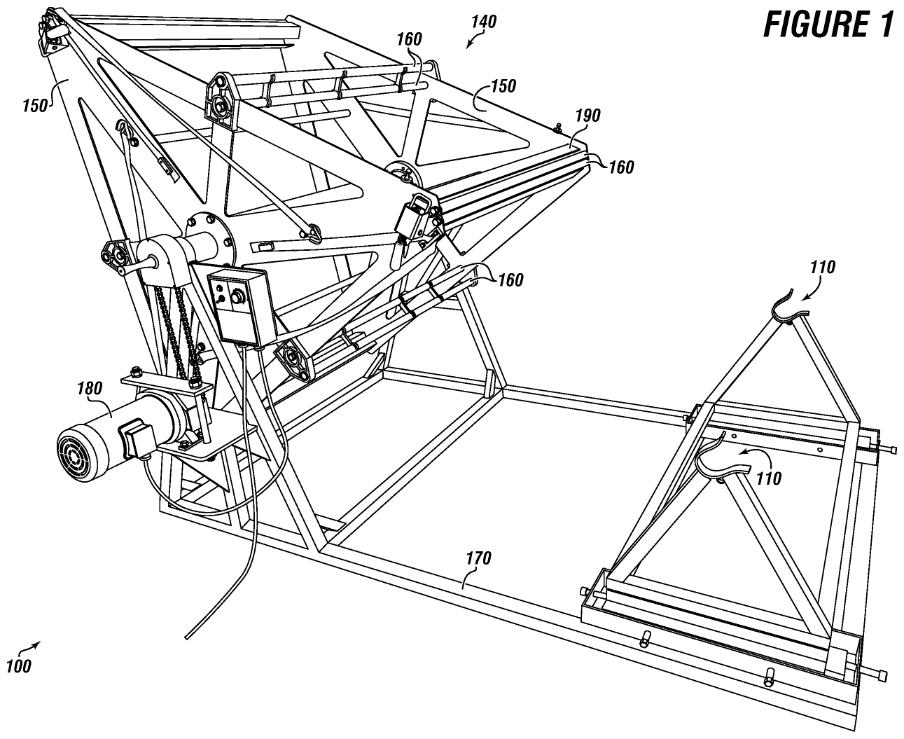

Turning now to the Figures, FIG. 1 is a perspective view of the system for mass producing templates from plastic film.

The system 100 can have axle slots 110 for receiving a roll of film, track 170 for positioning the axle slots 110, and polygonal wheel 140 with respect to one another.

A motor 180 can be used to rotate the polygonal wheel 140. The polygonal wheel can have sides 150. In embodiments, the number of sides 150 can be changed to change the shape of the polygon. While a regular polygon is shown here, the sides 150 can be of varying lengths to allow for multiple plastic sheet sizes to be cut from a roll of plastic film. First fastener 190 can be used to attach the film to the polygonal wheel.

Cross member 160 can determine the width of the polygonal wheel 140

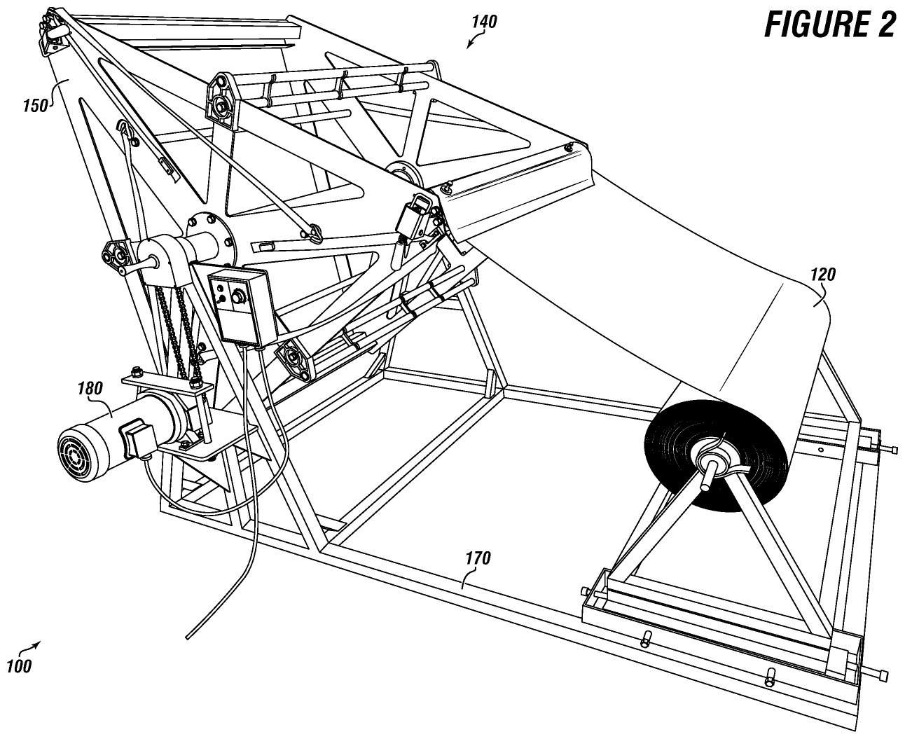

FIG. 2 depicts a perspective view of an embodiment of the system for mass producing templates from plastic film with a roll of plastic film.

The roll of plastic film 120 can be wrapped around an axle and placed within the axle slots. The sheet can be pulled to the polygonal wheel 140 and attached using the first fastener.

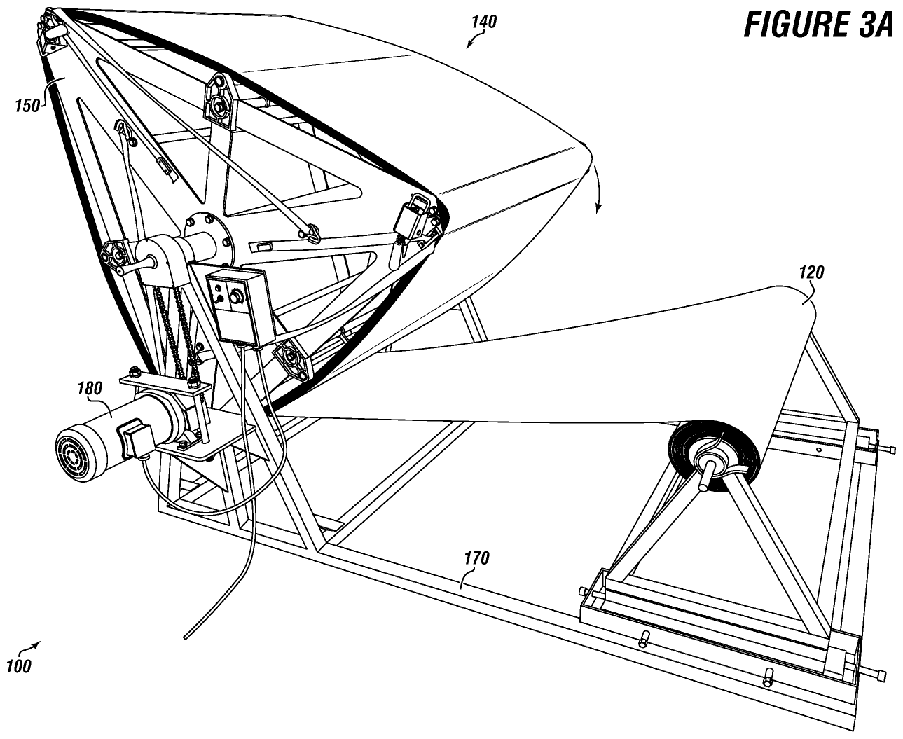

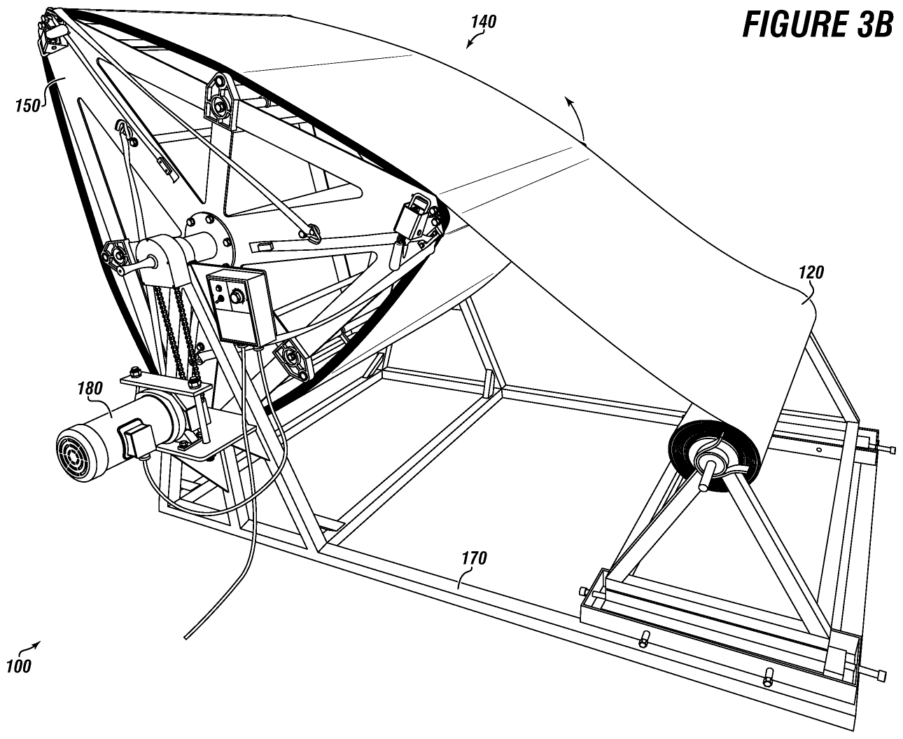

FIGS. 3A and 3B depicts a perspective view of an embodiment of the system for mass producing templates from plastic film with the film being unrolled.

By rotating the polygonal wheel 140, the plastic film is wrapped around the polygonal wheel 140 and can be cut to a desired length.

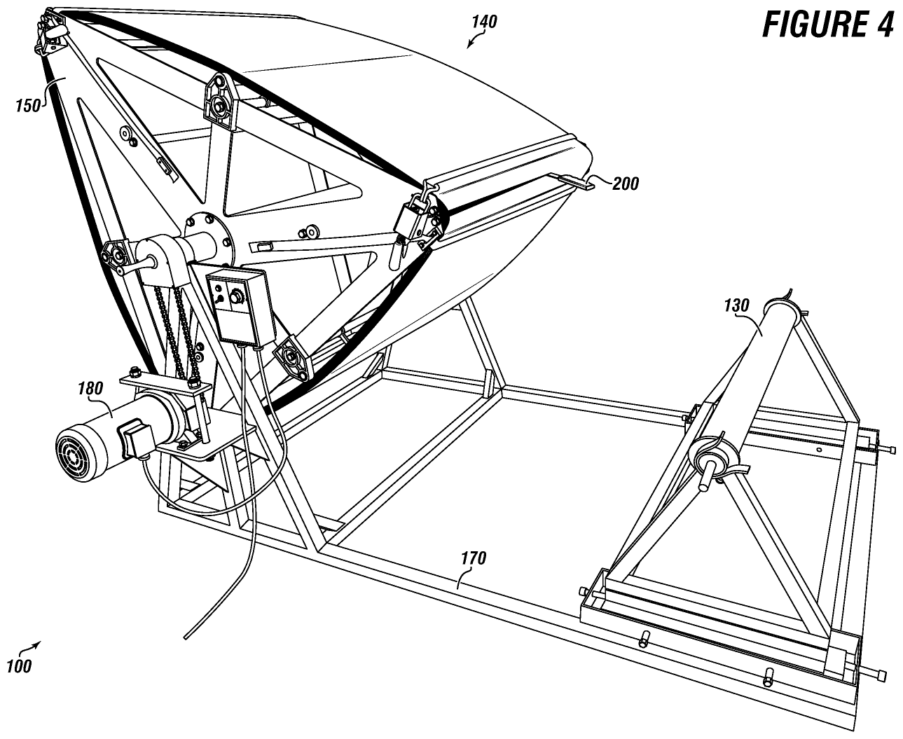

FIG. 4 depicts a perspective view of an embodiment of the system for mass producing templates from plastic film with the film having been unrolled.

Axle 130 about which the film was rolled is shown here. A first cutter 200 can be used to cut the film to a desired length. While it is convenient to cut the film at the vertices of the polygon forming the polygonal wheel 140, persons having ordinary skill in the art can cut the film at any desired point. Further, angle cuts can be used to create plastic sheets which are not rectangular in shape.

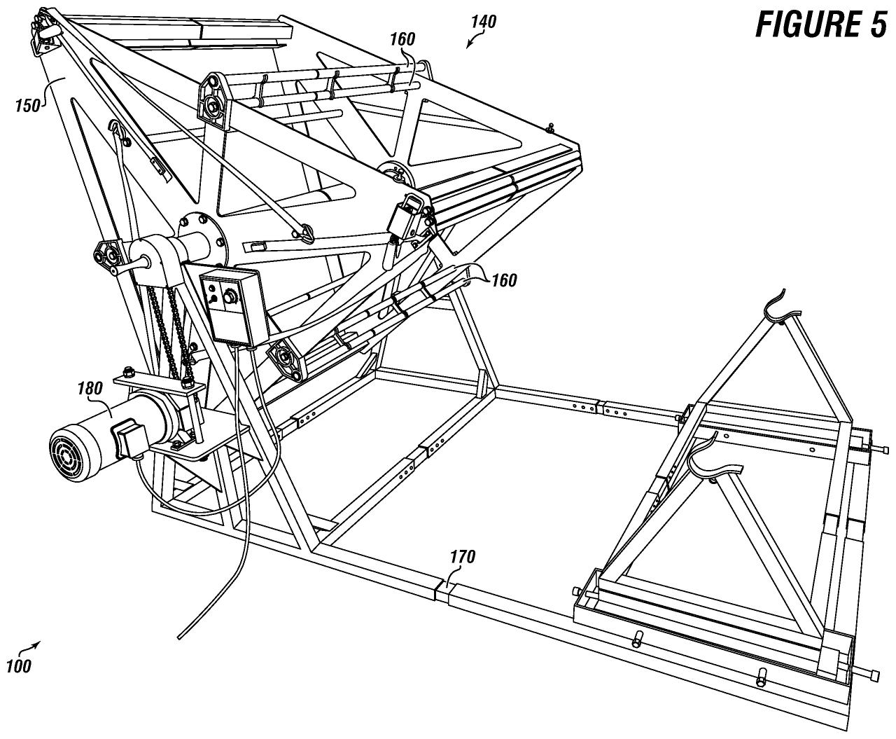

FIG. 5 depicts a perspective view of an embodiment of the system for mass producing templates from plastic film.

In embodiments, the track 170 can be adjustable in length. Various means of doing so are already known in the art, such as using overlapping sections fastened together, using telescoping members, using sections that are fastenable together, and the like.

Similarly, the width of the polygonal wheel 140 can be adjusted to accommodate various widths of plastic film by adjusting the length of cross members. Persons having ordinary skill in the art can determine the best means of adjusting the length of cross members based upon the specific application.

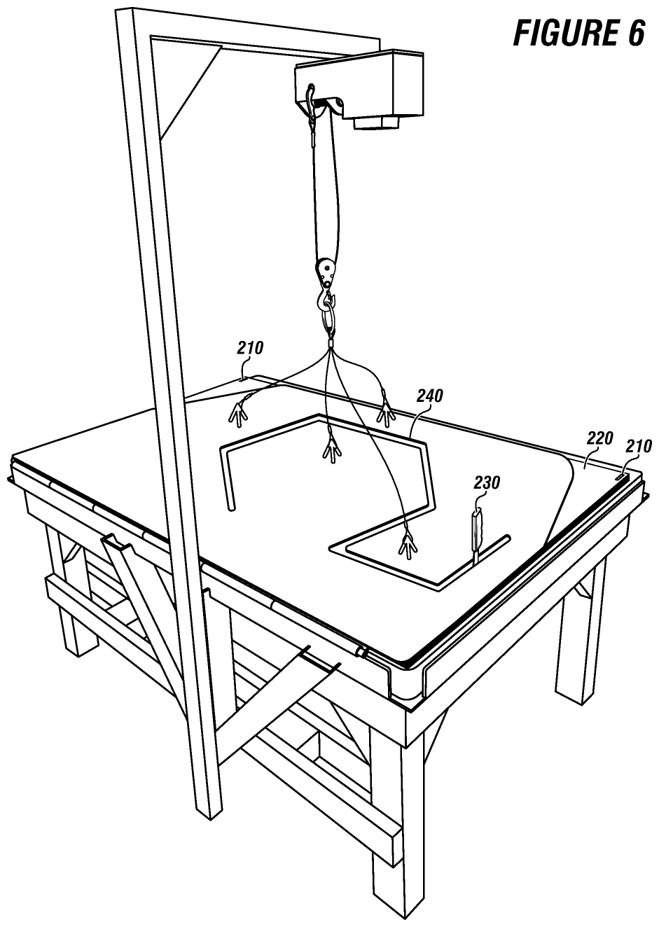

FIG. 6 depicts a perspective view of an embodiment of a cutter for the system for mass producing templates from plastic film.

Here, second fastener 210 holds the sheets of plastic film 220 together while second cutter 230 is used in conjunction with a template 240 to cut specific shapes in mass quantities from the plastic film.

While the present disclosure emphasizes the presented embodiments and Figures, it should be understood that within the scope of the appended claims, the disclosure might be embodied other than as specifically enabled herein

What is claimed is:

1. A system for mass producing templates from film comprising:
a. an axle slot to receive an axle comprising a roll of film, wherein the axle allows the roll of film to rotate freely;
b. a polygonal wheel, wherein a width of the polygonal wheel is at least a width of the roll of film, and further wherein each side of the polygonal wheel is of a user defined length;
c. a first fastener to removably attach film from the roll of film to the polygonal wheel;
d. a cutter for cutting the film from the roll of film into sheets of film of a user defined length; and
e. a second fastener for fastening the sheets of film to form a stack of sheets of film.

2. The system of claim 1, further comprising a second cutter for cutting templates in the stack of sheets of film.

3. The system of claim 1, further comprising a motor for rotating the polygonal wheel.

4. The system of claim 1, wherein the axle is a dowel, a rod, a tubular, a cylinder, or a hollow cylinder.

5. The system of claim 1, wherein the width of the polygonal wheel is adjustable.

6. The system of claim 1, wherein the user defined length is adjustable.

7. The system of claim 1, wherein the polygonal wheel in cross section is:
a. a triangle;
b. a quadrilateral;
c. a pentagon;
d. a hexagon;
e. a heptagon; or
f. an octagon.

8. The system of claim 1, wherein the polygonal wheel in cross section is a regular polygon.

9. The system of claim 1, wherein the polygonal wheel in cross section has sides of various lengths.

10. The system of claim 1, wherein the number of sides of the polygonal wheel is adjustable by adding or removing one or more sides.

11. A method for mass producing templates from film comprising:
a. providing the system of claim 1;
b. placing the roll of film on an axle within the axle slot;
c. using the first fastener to connect the film from the roll of film to the polygonal wheel;
d. rotating the polygonal wheel such that the film is wrapped about the polygonal wheel;
e. cutting the film while attached to the polygonal wheel to form sheets of film;
f. using the second fastener to fasten the sheets of film to form a stack of sheets of film;
g. cutting a template into the stack of sheets of film;
h. separating the stack of sheets of film into separate sheets cut into templates.
